(19) United States
(12) Patent Application Publication
(10) Pub. No.: US 2015/0186163 A1
(43) Pub. Date: Jul. 2, 2015

(54) APPLICATION VIRTUALIZATION SYSTEM AND METHOD

(71) Applicant: Tsinghua University, Beijing (CN)

(72) Inventors: YONGWEI WU, Beijing (CN); KANG CHEN, Beijing (CN); WENLEI ZHU, Beijing (CN); WEIMIN ZHENG, Beijing (CN)

(21) Appl. No.: 14/580,565

(22) Filed: Dec. 23, 2014

(30) Foreign Application Priority Data
Dec. 26, 2013 (CN) 201310733560.3

(51) Int. Cl. G06F 9/455; G06F 9/445

(52) U.S. Cl. CPC G06F 9/455; G06F 8/61; G06F 9/44505

(57) ABSTRACT

In an application virtualization method, a first scanning step for scanning a target operation system and recording document information and registry information of the target operation system; a tracking step for installing an application to the target operation system and tracking operations to the document information and the registry information of the target operation system during installing the application; a second scanning step for scanning the target operation system and obtaining changes of the document information and the registry information of the operation system; and a launcher generating step for generating a launcher for starting up the application according to the changes of the document information and the registry information of the operation system are included. The present disclosure also provides an application virtualization system. Virtualization level is increased by the method and the system.

### CROSS-REFERENCE TO RELATED APPLICATION

This application claims priority to and benefits of Chinese Patent Application Serial No. 201310733560.3, filed with the State Intellectual Property Office of P. R. China on Dec. 26, 2013, the entire contents of which are incorporated herein by reference.

### FIELD

The present disclosure relates to virtualization technologies, and more particularly to an application virtualization system and method.

### BACKGROUND

With the development of computer technologies, virtualization technologies are widely used.

The virtualization includes three levels: operation system virtualization, platform virtualization, and application virtualization. The operation system virtualization clients such as Qemu, VMWare Workstation, and VirtualBox are parts of the bottom level of virtualization. The platform virtualization such as Java platform is the second level of virtualization. The application virtualization is a higher level of virtualization and can configure virtualization environment such that applications can run independently of operating system resources.

However, at present, the application virtualization has shortcomings: high failure rate, not generalized, and requiring special technologies for use.

### SUMMARY

According to an aspect of the present disclosure, an application virtualization method includes:

a first scanning step for scanning a target operation system and recording document information and registry information of the target operation system;

a tracking step for installing an application to the target operation system and tracking operations to the document information and the registry information of the target operation system during installing the application;

a second scanning step for scanning the target operation system and obtaining changes of the document information and the registry information of the operation system; and

a launcher generating step for generating a program launcher for starting up the application according to the changes of the document information and the registry information of the operation system.

In some embodiments, the method includes:

a restoring step for restoring the document information and the registry information of the operation system back to a state before the application is installed.

In some embodiments, the method includes:

a determining step for determining if the application runs properly after the application is started up by the launcher;

an analyzing step for analyzing using dynamic tracking, dynamic debugging, and code instrumentation if the application does not run properly; and

an exception handling step for processing documents or registries according to results of analyzing to make the application runs properly.

In some embodiments, the second scanning step and the launcher generating step are performed again after the exception handling step.

In some embodiments, the method includes:

installing an environment before the first scanning step if the application runs depending on the environment.

In some embodiments, the method includes:

installing an environment after the first scanning step if the application runs depending on the environment and uninstalling the environment in the restoring step.

In some embodiments, the method includes:

a deleting step for deleting parts of the changes of the document information and the registry information that are not related to the application.

In some embodiments, the first scanning step is carried out by a regshot scanning tool.

In some embodiments, the tracking step is carried out by a Regfromapp or Procmon tool.

An application virtualization system, includes

a first scanning module configured for scanning a target operation system and recording document information and registry information of the target operation system;

a tracking module configured for installing an application to the target operation system and tracking operations to the document information and the registry information of the target operation system during installing the application;

a second scanning module configured for scanning the target operation system and obtaining changes of the document information and the registry information of the operation system; and

a launcher generating module configured for generating a launcher for starting up the application according to the changes of the document information and the registry information of the operation system.

The application virtualization system and method generating the launcher for starting up the application according to the changes of the document information and the registry information of the operation system, thus, the virtualization level of the application is increased and the application can be universally used on different operation systems.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings in which:

FIG. 1 is a functional block diagram of an application virtualization system according to an embodiment of the present disclosure.

FIG. 2 is a flowchart of an application virtualization method according to an embodiment of the present disclosure.

### DETAILED DESCRIPTION

Embodiments of the present disclosure will be described in detail in the following descriptions, examples of which are shown in the accompanying drawings, in which the same or similar elements and elements having same or similar functions are denoted by like reference numerals throughout the descriptions. The embodiments described herein with reference to the accompanying drawings are explanatory and illustrative, which are used to generally understand the present disclosure. The embodiments shall not be construed to limit the present disclosure.

Various embodiments and examples are provided in the following description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied. Moreover, a structure in which a first feature is “on” a second feature may include an embodiment in which the first feature directly contacts the second feature, and may also include an embodiment in which an additional feature is formed between the first feature and the second feature so that the first feature does not directly contact the second feature.

In addition, terms such as “first” and “second” are used herein for purposes of description and are not intended to indicate or imply relative importance or significance or imply a number of technical features indicated. Therefore, a “first” or “second” feature may explicitly or implicitly comprise one or more features. Further, in the description, unless indicated otherwise, “a plurality of” refers to two or more.

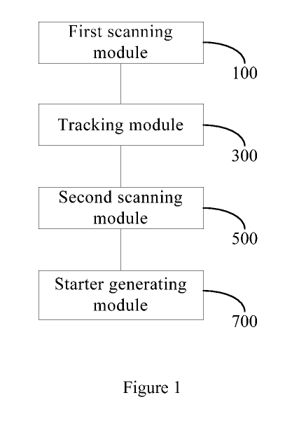

FIG. 1 is a functional block diagram of an application virtualization system according to an embodiment of the present disclosure. The application virtualization system includes a first scanning module 100, a tracking module 300, a second scanning module 500, and a launcher generating module 700.

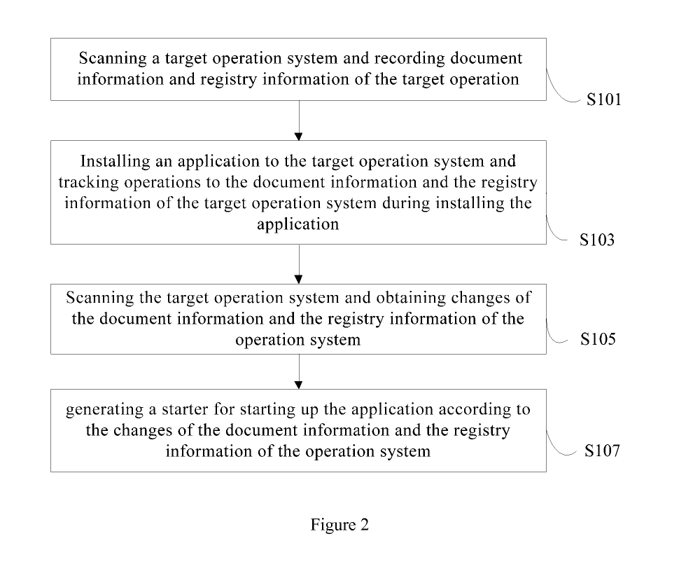

FIG. 2 is a flowchart of an application virtualization method according to an embodiment of the present disclosure. The application virtualization method includes:

S101: a first scanning step for scanning a target operation system and recording document information and registry information of the target operation system;

S103: a tracking step for installing an application to the target operation system and tracking operations to the document information and the registry information of the target operation system during installing the application;

S105: a second scanning step for scanning the target operation system and obtaining changes of the document information and the registry information of the operation system; and

S107: a launcher generating step for generating a launcher for starting up the application according to the changes of the document information and the registry information of the operation system.

The first scanning step can be carried out by the first scanning module 100. That is, the first scanning module 100 is configured for scanning the target operation system and recording the document information and the registry information of the target operation system. The tracking step can be performed by the tracking module 300. That is, the tracking module 300 is configured for installing the application to the target operation system and tracking the operations to the document information and the registry information of the target operation system during installing the application. The second scanning step can be performed by the second scanning module 500. That is, the second scanning module 500 is configured for scanning the target operation system and obtaining the changes of the document information and the registry information of the operation system. The launcher generating step can be carried out by the launcher generating module 700. That is, the launcher generating module 700 is configured for generating the launcher for starting up the application according to the changes of the document information and the registry information of the operation system.

The application virtualization system and method generating the launcher for starting up the application according to the changes of the document information and the registry information of the operation system, thus, a virtualization level of the application is increased and the application can be universally installed to different operation systems.

In this embodiment, the first scanning step is carried out by a regshot scanning tool to record system state information, the document information, and the registry information of the operation system. For example, the whole registry can be exported by the regshot scanning tool “regedit” and converted into a document of “.reg” format.

In this embodiment, if the application runs depending on an environment, the environment can be installed before the first scanning step. In another embodiment, the environment can be installed after the first scanning step and is uninstalled the environment after the application is run. The environment can be installed and uninstalled by the first scanning module 100.

In this embodiment, the tracking step is carried out by a Regfromapp or Procmon tool to record the system state information, the document information, and the registry information of the operation system. For example, the whole registry can be exported by the regshot scanning tool “regedit” and converted into a document of “.reg” format.

In this embodiment, the target operation system is scanned after the application is installed in the second scanning step, and scanning results are compared with scanning results of the first scanning step to obtain the changes of the document information and the registry information of the operation system. For example, by comparing the documents of the “.reg” format exported in the first scanning step and the second scanning step, the changes of the document information and the registry information of the operation system can be obtained. A deleting step for deleting parts of the changes of the document information and the registry information that are not related to the application is carried out. This can be done by the second scanning module 500.

In this embodiment, in the launcher generating step, the launcher can start up the application according to user's requests. After the application is run, a restoring step for restoring the document information and the registry information of the operation system back to a state before the application is installed is carried out. The launcher can be generated using NSIS script system or Visual Studio.

In some embodiments, the launcher is used for recording and backing up system information and configuring the registry information, the document information and system service for the application to start up the application. When the application exits, the launcher turns off and installs drivers and restores the document information and registry information back to a state the application is started up.

In an embodiment, after the application is installed by the launcher, a determining step for determining if the application runs properly is carried out. If the application does not run properly, an analyzing step for analyzing using dynamic tracking, dynamic debugging, and code instrumentation is performed. An exception handling step for processing documents or registries according to results of analyzing to make the application runs properly is then carried out. The second scanning step and the launcher generating step are carried out again after the launcher runs properly. The exception handling step can be carried out by a combiner or a hex editor.

In this embodiment, the application virtualization system may include a determining module for carrying out the determining step, an analyzing module for carrying out the analyzing step, and an exception handling module for carrying out the exception handling step.

Examples of exceptions and corresponding exception handling methods include:

Exception (1): the application can be started up, however, part of contents do not display or load properly. This exception is typically caused by missing resource files or configuration files. Thus, a process monitor or other application processes monitoring toolscan be used to find out the state that the resource files are accessed and find out failure resource requests, and resource request address, and check failure reasons to perform corresponding processes such as reloading.

Exception (2): errors happen during the application loading, for example, lacking of running library. This exception happens because that the application cannot find the environment on which the application runs depending and can be solved by: do not virtualize an environment library, and directly installing the environment library for simplifying operations; or virtualizing the environment library by the way similar to the virtualization of the application.

Exception (3): the application can be started up, however, a message displaying wrong registry configuration is popped up. This exception is caused by insufficient virtualization of the application. The environment for the virtualized application should be the same as the environment before the application is virtualized. If the environment is not prepared, then the application may not access the registry information in need. Solutions include finding out all registries, documents on which the application depends and completing the virtualization.

Exception (4): the application can be started up and collapses. This exception is caused by mistakes of programmers for insufficient checking of codes. Reasons include: key error of the registry, which causes program access errors. This can be solved by dynamic debugger, such as ollydbg, windbg.

Exception (5): the application depends on system service or drivers, and cannot be started up without installation of the system service or the drivers. This can be handled by: installing the system service or the drivers before starting up the application and turning off the application first and then the system service or the drivers.

Reference throughout this specification to “an embodiment”, “some embodiments”, “one embodiment”, “an example”, “a specific examples”, or “some examples” means that a particular feature, structure, material, or characteristic described in connection with the embodiment or example is included in at least one embodiment or example of the disclosure. Thus, the appearances of the phrases such as “in some embodiments”, “in one embodiment”, “in an embodiment”, “an example”, “a specific example”, or “some examples” in various places throughout this specification are not necessarily referring to the same embodiment or example of the disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications may be made in the embodiments without departing from spirit and principles of the disclosure. Such changes, alternatives, and modifications all fall into the scope of the claims and their equivalents.

What is claimed is:

1. An application virtualization method, comprising:
a first scanning step for scanning a target operation system and recording document information and registry information of the target operation system;
a tracking step for installing an application to the target operation system and tracking operations to the document information and the registry information of the target operation system during installing the application;
a second scanning step for scanning the target operation system and obtaining changes of the document information and the registry information of the operation system; and
a launcher generating step for generating a launcher for starting up the application according to the changes of the document information and the registry information of the operation system.

2. The application virtualization method of claim 1, further comprising:
a restoring step for restoring the document information and the registry information of the operation system back to a state before the application is installed.

3. The application virtualization method of claim 2, further comprising:
a determining step for determining if the application runs properly after the application is started up by the launcher;
an analyzing step for analyzing using dynamic tracking, dynamic debugging, and code instrumentation if the application does not run properly; and
an exception handling step for processing documents or registries according to results of analyzing to make the application runs properly.

4. The application virtualization method of claim 3, wherein the second scanning step and the launcher generating step are performed again after the exception handling step.

5. The application virtualization method of claim 1, further comprising:
installing an environment before the first scanning step if the application runs depending on the environment.

6. The application virtualization method of claim 2, further comprising:
installing an environment after the first scanning step if the application runs depending on the environment and uninstalling the environment in the restoring step.

7. The application virtualization method of claim 1, further comprising:
a deleting step for deleting parts of the changes of the document information and the registry information that are not related to the application.

8. The application virtualization method of claim 1, wherein the first scanning step is carried out by a regshot scanning tool.

9. The application virtualization method of claim 1, wherein the tracking step is carried out by a Regfromapp or Procmon tool.

10. An application virtualization system, comprising:
a first scanning module configured for scanning a target operation system and recording document information and registry information of the target operation system;
a tracking module configured for installing an application to the target operation system and tracking operations to the document information and the registry information of the target operation system during installing the application;
a second scanning module configured for scanning the target operation system and obtaining changes of the document information and the registry information of the operation system; and
a launcher generating module configured for generating a launcher for starting up the application according to the changes of the document information and the registry information of the operation system.
